(19) United States
(12) Patent Application Publication
(10) Pub. No.: US 2007/0071628 A1
(43) Pub. Date: Mar. 29, 2007

(54) COMPRESSOR

(75) Inventor: Joseph A. Newland, Britton, MI (US)

Correspondence Address: BAKER & DANIELS LLP;111 E. WAYNE STREET, SUITE 800, FORT WAYNE, IN, 46802, US

(73) Assignee: TECUMSEH PRODUCTS COMPANY, Tecumseh, MI (US)

(21) Appl. No.: 11/534,319

(22) Filed: Sep. 22, 2006

Related U.S. Application Data
(60) Provisional application No. 60/721,934, filed on Sep. 29, 2005.

(51) Int. Cl. F16N 13/20; F04C 2/00; F01C 19/02; F04C 27/00; F01C 1/02

(52) U.S. Cl. 418/125; 418/63; 418/126

(57) ABSTRACT

A multi-stage compressor having a shaft with two eccentrics that are offset with respect to the shaft axis of rotation in substantially the same radial direction, compressor also having two vanes oriented in substantially opposite radial directions with respect to shaft axis. Also, a multi-stage compressor having a first-stage cylinder for compressing a fluid, e.g., a refrigerant, from a low pressure to an intermediate pressure, a second-stage cylinder for compressing the refrigerant from the intermediate pressure to a high pressure, and a housing having an intermediate-pressure refrigerant outlet in direct fluid communication with the first-stage cylinder and an intermediate-pressure refrigerant return inlet in fluid communication with the interior of the compressor housing. Also, a compressor having a vane operably engaged with a shaft eccentric and a spring biasing the vane toward the eccentric, wherein the amount of biasing force applied by the spring is adjustable.

### CROSS-REFERENCE TO RELATED APPLICATION

This application claims the benefit under Title 35, U.S.C. § 119(e) of U.S. Provisional Patent Application Ser. No. 60/721,934, entitled COMPRESSOR, filed on Sep. 29, 2005.

### BACKGROUND OF THE INVENTION

1. Field of the Invention

The present invention relates to compressors, and, more specifically, to two-stage compressors.

2. Description of the Related Art

Two-stage compressors typically include a housing and a motor having a crankshaft positioned within the housing. Often, two-stage compressors also include two rollers, wherein each roller is interfitted with one of two eccentrics on the crankshaft. As is known in the art, a two-stage compressor has two compression stages, i.e., a first stage for compressing a fluid, e.g., a refrigerant, from a low pressure to an intermediate pressure and a second stage for compressing the refrigerant from the intermediate pressure to a high pressure. In the first stage, the refrigerant enters into a first cylinder where it is compressed by a roller positioned therein. The refrigerant is then discharged into a second cylinder, i.e., the second stage, and is also compressed by a roller positioned therein. More specifically, in each of the cylinders, refrigerant is compressed between the roller positioned within the cylinder, the walls of the cylinder, and a vane biased against the roller. In operation, a volume of refrigerant is compressed into a progressively smaller volume by the roller until the pressure of the refrigerant is sufficient to open a discharge valve covering a port in the cylinder. The refrigerant is then discharged into the interior of the compressor housing and/or discharged into a refrigeration system.

In existing two-stage compressors, both of the cylinders are arranged such that the vanes within the cylinders are oriented in substantially the same radial direction with respect to the crankshaft. Further, in existing two-stage compressors, the eccentrics are eccentric with respect to shaft in substantially opposite directions, i.e., the eccentrics are 180 degrees out-of-phase with each other. As a result, the sequences of the two stages will occur 180 degrees out-of-phase, however, the refrigerant will be compressed on substantially the same side of the fixed bearings rotatably supporting the crankshaft, i.e., adjacent the substantially aligned vanes. As a result, in operation, forces created by the compression portions of the two stage sequences will act on the shaft from the same radial direction. This causes wear to be substantially concentrated in one location on each of the fixed bearings.

### SUMMARY OF THE INVENTION

The present invention includes a multi-stage compressor having a first-stage cylinder for compressing a fluid, e.g., a refrigerant, from a low pressure to an intermediate pressure and a second-stage cylinder for compressing the refrigerant from the intermediate pressure to a high pressure. In one exemplary embodiment, the multi-stage compressor includes a housing having an intermediate-pressure refrigerant outlet in fluid communication with the first-stage cylinder and an intermediate-pressure refrigerant return inlet in fluid communication with the interior of the compressor housing. In another exemplary embodiment, refrigerant exiting the compressor housing through the intermediate-pressure outlet can be cooled before returning into the compressor housing. The cooled refrigerant can be directed to flow over and cool the compressor motor positioned in the housing. In another exemplary embodiment, the first-stage cylinder may discharge intermediate-pressure refrigerant directly into the housing plenum. In this exemplary embodiment, the refrigerant can be directed to flow over and cool the compressor motor before exiting the compressor housing through the intermediate-pressure outlet. The refrigerant may then be cooled before returning to the intermediate-pressure refrigerant return inlet which is in direct fluid communication with the second stage cylinder.

The present invention, in one form thereof, also includes a multi-stage compressor having a shaft with two eccentrics that are offset with respect to the shaft axis of rotation in substantially the same radial direction. In one embodiment, the compressor further includes two vanes, each vane operably engaged with a rolling piston positioned on an eccentric, wherein the vanes are oriented in substantially opposite radial directions with respect to the shaft axis of rotation. In this embodiment, the compression sequences of the two stages are 180 degrees out-of-phase with each other and the refrigerant is compressed on substantially opposite sides of the fixed bearings.

The present invention also includes a compressor having a vane operably engaged with and biased toward a rolling piston positioned on a shaft eccentric by a biasing force, wherein the amount of biasing force is adjustable. In one embodiment, the compressor includes a roller interfitted with a shaft eccentric, a vane biased against the roller by a spring, wherein the spring is compressed between the vane and an adjustable fastener threadingly engaged with the compressor. In use, the fastener can be adjusted to increase or decrease the compression of the spring to thereby increase or decrease the force between the roller and the vane.

In one form of the invention, a compressor comprises a housing, a crankshaft rotatably mounted in the housing, the crankshaft having an axis of rotation, the crankshaft including a first eccentric and a second eccentric, the first eccentric and the second eccentric offset with respect to the axis in substantially the same radial direction, a first cylinder, the first eccentric positioned within the first cylinder, and a second cylinder, the second eccentric positioned within the second cylinder.

In one form of the invention, a compressor comprises a housing having a plenum, a suction inlet, an intermediate-pressure outlet, an intermediate-pressure inlet in fluid communication with the plenum, and a discharge outlet, a motor including a crankshaft, the crankshaft rotatably mounted in the housing, a first cylinder having a suction inlet and an intermediate-pressure discharge outlet, the first cylinder suction inlet in direct fluid communication with the housing suction inlet, the first cylinder intermediate-pressure discharge outlet in direct fluid communication with the housing intermediate-pressure outlet, a second cylinder having an intermediate-pressure suction inlet in fluid communication with the housing plenum, the second cylinder further having a discharge outlet in direct fluid communication with the housing discharge outlet.

In one form of the invention, a compressor comprises a housing, a shaft including an eccentric, a cylinder block, the cylinder block including a cylinder, the eccentric positioned within the cylinder, the cylinder block further including a recess, a vane, wherein at least a portion of the vane is positioned in the recess, a fastener engaged with the cylinder block, and a spring, wherein at least a portion of the spring is positioned in the recess intermediate the vane and the fastener.

### BRIEF DESCRIPTION OF THE DRAWINGS

The above-mentioned and other features and objects of this invention will become more apparent and the invention itself will be better understood by reference to the following description of an embodiment of the invention taken in conjunction with the accompanying drawings, wherein:

FIG. 1 is a perspective view of a two-stage compressor in accordance with an embodiment of the present invention;

FIG. 2 is a detail view of the crankshaft of compressor of FIG. 1;

FIG. 3 is a cross-sectional view of the compressor of FIG. 1 taken along line 3-3 in FIG. 1; and

FIG. 4 is a cross-sectional view of the compressor of FIG. 1 taken along line 4-4 in FIG. 1.

Corresponding reference characters indicate corresponding parts throughout the several views. Although the exemplification set out herein illustrates an embodiment of the invention, the embodiment disclosed below is not intended to be exhaustive or to be construed as limiting the scope of the invention to the precise form disclosed.

### DETAILED DESCRIPTION

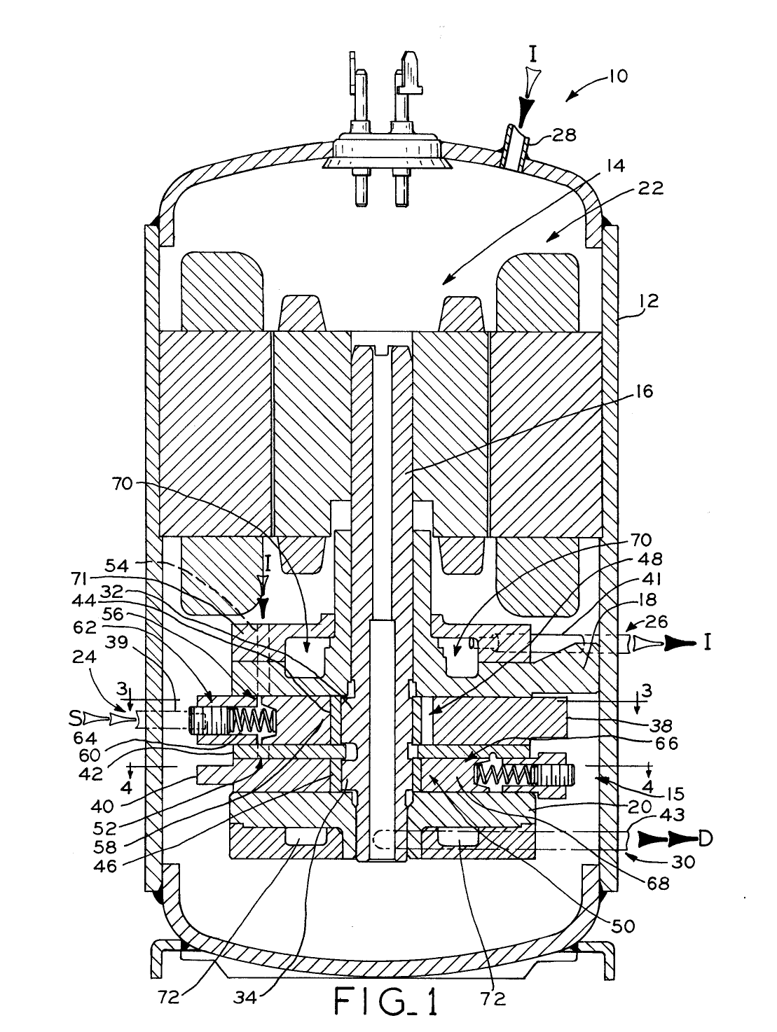

Referring to FIG. 1, compressor 10 includes housing 12, compression mechanism 15 and motor 14, where compression mechanism 15 and motor 14 are positioned within housing 12. Motor 14 includes crankshaft 16 rotatably supported by main bearing 18 and outboard bearing 20. Referring to FIGS. 1, 3 and 4, housing 12 includes first-stage suction inlet 24, intermediate-pressure refrigerant discharge outlet 26, intermediate-pressure refrigerant return inlet 28 and discharge outlet 30.

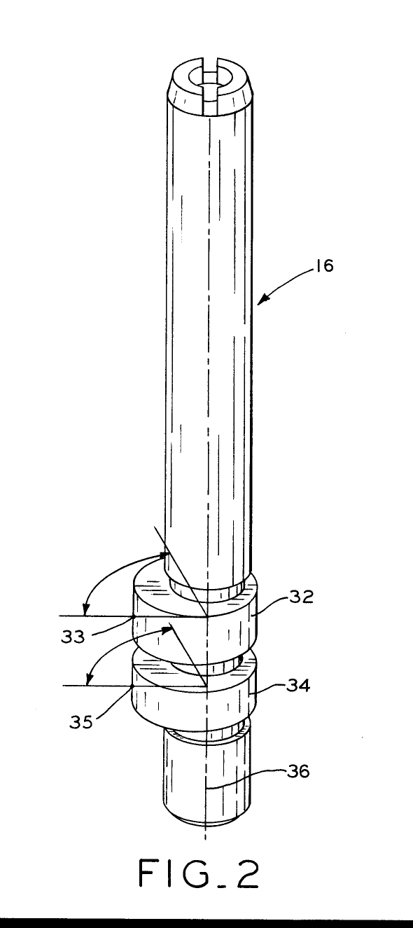

Referring to FIG. 2, crankshaft 16 includes first eccentric 32 and second eccentric 34. Eccentrics 32 and 34 are substantially round and the centers of eccentrics 32 and 34 are offset, or eccentric, with respect to axis of rotation 36 of crankshaft 16. In this embodiment, eccentrics 32 and 34 are offset in substantially the same radial direction with respect to axis of rotation 36. More particularly, the most distal points of eccentrics 32 and 34 with respect to axis of rotation 36, i.e., points 33 and 35, respectively, are at substantially the same angle of rotation on crankshaft 16.

Referring to FIGS. 1, 3 and 4, compression device 15 includes first stage cylinder block 38, second stage cylinder block 40 and separator plate 42 positioned intermediate first stage cylinder block 38 and second stage cylinder block 40. First stage cylinder block 38, separator plate 42 and second stage cylinder block 40 are fastened together via fasteners (not illustrated) extending through fixed main bearing 18 and fixed outboard bearing 20. Separator plate 42 separates the first-stage cylinder and the second-stage cylinder and substantially prevents refrigerant from passing directly therebetween.

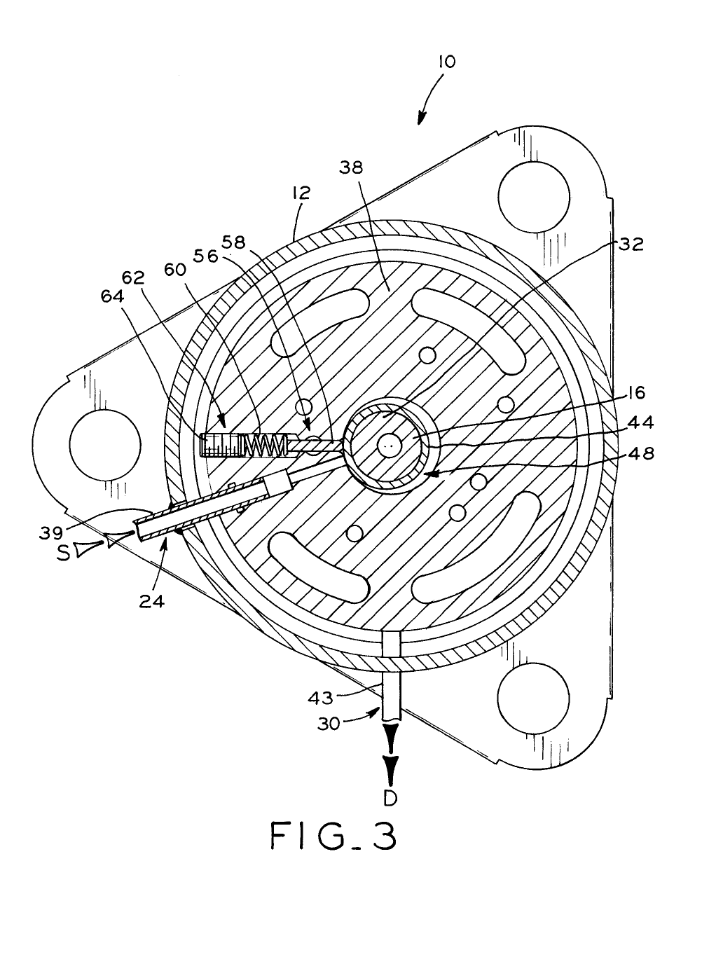

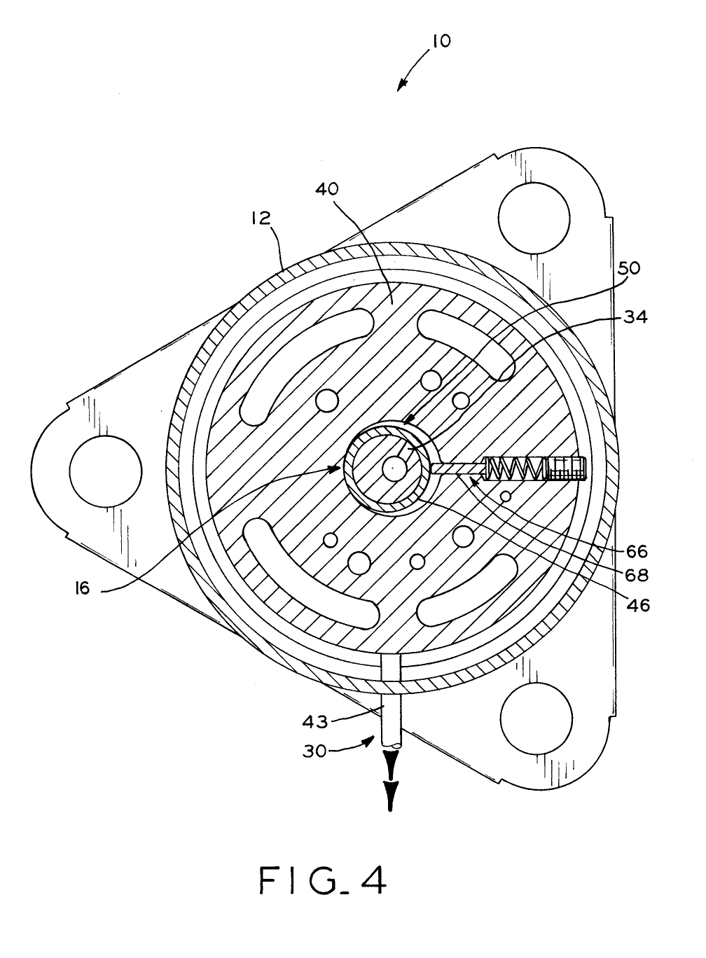

Compression device 15 further includes first roller 44 (FIGS. 1 and 3) positioned in first cylinder 48 of first-stage cylinder block 38. First roller 44 is closely interfitted with and rotates on first eccentric 32. Compression device 15 also includes second roller 46 (FIGS. 1 and 4) positioned in second cylinder 50 of second-stage cylinder block 40. Second roller 46 is closely interfitted with and rotates on second eccentric 34. In operation, rollers 44 and 46 are driven by the eccentrics within first cylinder 48 and second cylinder 50 to compress refrigerant therein.

Referring to FIGS. 1 and 3, first-stage cylinder block 38 includes recess 56 for receiving vane 58. In operation, vane 58 is biased against first roller 44 to divide first cylinder 48 into two chambers, i.e., one compression chamber and one suction chamber. Referring to FIGS. 1 and 4, second-stage cylinder block 40 includes recess 66 for receiving vane 68. In operation vane 68 is biased against second roller 46 to divide second cylinder 50 into two chambers. As illustrated in FIG. 1, vanes 58 and 68 are oriented in substantially opposite radial directions, i.e., 180 degrees out-of-phase with each other. Existing compressors include vanes that are oriented in the same radial direction, i.e., they are in-phase with each other.

As discussed above, eccentrics 32 and 34 are eccentric with respect to axis 36 in substantially the same radial direction. However, as discussed above, vanes 58 and 68 are oriented in substantially opposite radial directions. As a result, in operation, the compression sequences of the first stage and the second stage are substantially 180° out-of-phase with each other. Also, as a result, the refrigerant in the first-stage cylinder is compressed into a pocket and discharged from the first cylinder on substantially the opposite side of bearings 18 and 20 than the refrigerant in the second cylinder. In operation, as refrigerant is compressed into the pockets as described above, the refrigerant applies a pressure force against the rollers and cylinder walls. Some of this force is transmitted into the cylinder block, however, some of the force is transmitted into shaft 16 and then bearings 18 and 20. In the present embodiment, as the compression pockets occur on opposite sides of bearings 18 and 20, the forces act in substantially opposite radial directions toward axis 36 of shaft 16. As a result, these oppositely-acting forces will not substantially combine to create even larger forces in bearings 18 and 20. Also, the oppositely-acting forces may partially cancel each other out before being transmitted into bearings 18 and 20, thereby reducing the load received by, and the wear of, bearings 18 and 20.

In previous two cylinder compressors, the compression pockets occurred on the same side of the crankshaft. As a result, during the compression sequences of the first stage and second stage cylinders, the loads transmitted into the bearings would be applied to the same locations on the bearings. Accordingly, this could cause greater wear of the bearings than the present embodiment.

In the present embodiment, in operation, refrigerant at suction pressure is drawn through suction inlet 24 into first stage cylinder block 38. More particularly, the refrigerant, represented by arrow S, is drawn directly into cylinder block 38 from inlet 24 through pipe 39. The refrigerant is then compressed by roller 44 within first cylinder 48 to an intermediate pressure. Thereafter, the intermediate-pressure refrigerant is discharged into muffler chamber 70 through a discharge valve. The intermediate-pressure refrigerant, represented by arrow I, is then discharged out of housing 12 through pipe 41 and intermediate-pressure discharge outlet 26. Stated in another way, first cylinder 48 and discharge outlet 26 are in direct fluid communication, i.e., the intermediate-pressure refrigerant exiting first cylinder 48 does not substantially enter interior plenum 22 of compressor 12.

Thereafter, in one embodiment, the refrigerant flows through a conduit which is in thermal communication with an ambient environment that absorbs heat from the refrigerant. In one embodiment, the refrigerant passes into a heat exchanger (not shown) having a second fluid in thermal communication with the refrigerant to absorb heat therefrom. The intermediate-pressure refrigerant, represented by arrow I, then flows back into housing 12 through intermediate-pressure return inlet 28 and flows into interior plenum 22 of housing 12. Thereafter, the intermediate-pressure refrigerant is drawn into suction inlet 52 (FIG. 1) of second stage cylinder block 40.

In this embodiment, suction inlet 52 is in fluid communication with interior plenum 22 through passage 54 extending through muffler 71, main bearing 18, first stage cylinder block 38 and separator plate 42. Advantageously, the cooled, intermediate-pressure refrigerant entering into interior plenum 22 passes over and cools motor 14 before entering passage 54 and suction inlet 52. Cooling motor 14 in this manner may increase the longevity of motor 14. Thereafter, the refrigerant is compressed by second roller 46 positioned within second cylinder 50 to a high pressure. Thereafter, the high-pressure refrigerant is discharged into muffler chamber 72 through a discharge valve. The high-pressure refrigerant, represented by arrow D, is then discharged from housing 12 through pipe 43 and discharge outlet 30. Stated in another way, second cylinder 50 and discharge outlet 30 are in direct fluid communication, i.e., the high-pressure refrigerant exiting second cylinder 50 does not substantially enter interior plenum 22 of compressor 12.

In another exemplary embodiment, housing 12 lacks pipe 41 and discharge outlet 26. In this embodiment, first cylinder 48 discharges intermediate-pressure refrigerant into muffler chamber 70 through a discharge valve. The intermediate-pressure refrigerant then exits muffler chamber 70 and enters interior plenum 22 of housing 12. Thereafter, the intermediate-pressure refrigerant exits housing 12 through pipe 28 and passes through a heat exchanger (not shown). The cooled refrigerant then flows back into housing 12 through an intermediate-pressure return inlet (not shown) and directly into second stage cylinder block 40 and is compressed to discharge pressure as discussed in detail above.

As discussed above, referring to FIGS. 1 and 2, first stage cylinder block 38 includes recess 56 for receiving vane 58. Vane 58 is biased against first roller 44 by spring 60 to divide first cylinder 48 into two chambers, one compression chamber and one suction chamber. In operation, owing to the eccentricity of roller 44, spring 60 is compressed between first and second lengths resulting in a range of biasing forces against vane 58. More particularly, spring 60 is compressed between a first compressed length and a second, more compressed length in which the biasing force created by the spring is greater than the biasing force created by the spring in the first length. In operation, spring 60 is cyclically compressed between these first and second lengths. In existing compressors, however, the range of biasing forces created by the spring is substantially fixed, i.e., the first and second spring lengths are not adjustable.

In the present embodiment, the range of spring lengths of spring 60 is adjustable. More particularly, referring to FIGS. 1 and 2, recess 56 includes threaded portion 62 which threadingly receives threaded fastener 64. In this embodiment, spring 60 is compressed between vane 58 and fastener 64, however, the compressed length of spring 60 can be increased or decreased by the position of fastener 64 in recess 56. More particularly, the compressed length of spring 60 can be shortened by threading fastener 64 inwardly toward axis of rotation 36 of shaft 16, thereby shortening the range in which spring 60 can be compressed. By shortening the range of spring 60, spring 60 will apply a greater biasing force against roller 44 throughout the operation of the compressor. Alternatively, the compressed length of spring 60 can be increased by threading fastener 64 outwardly away from axis of rotation 36 of shaft 16, thereby increasing the range in which spring 60 can be compressed. By increasing the range of spring 60, spring 60 will apply a lesser biasing force against roller 44 throughout the operation of the compressor. Further, fastener 64 may be adjusted to account for manufacturing tolerances of the compressor.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A compressor, comprising:
a housing;
a crankshaft rotatably mounted in said housing, said crankshaft having an axis of rotation and including a first eccentric and a second eccentric positioned thereon, said first eccentric and said second eccentric offset in substantially the same radial direction with respect to said axis of rotation;
a first vane contained within said housing and operably engaged with said first eccentric; and
a second vane contained within said housing and operably engaged with said second eccentric, wherein said first vane and said second vane are oriented in substantially opposite radial directions with respect to said axis of rotation.

2. The compressor of claim 1, further comprising:
a first cylinder block having a first cylinder and a first discharge port, said first eccentric positioned within said first cylinder; and
a second cylinder block having a second cylinder and a second discharge port, said second eccentric positioned within said second cylinder.

3. The compressor of claim 2, wherein said first discharge port and said second discharge port are oriented in substantially opposite radial directions with respect to said crankshaft axis.

4. The compressor of claim 2, further comprising:
a suction inlet in fluid communication with said first cylinder, whereby said first cylinder receives fluid at suction pressure and discharges fluid through said first discharge port at intermediate pressure; and
an intermediate pressure inlet in communication with said second cylinder, whereby said second cylinder receives fluid at intermediate pressure and discharges fluid through said second discharge port at discharge pressure.

5. The compressor of claim 2, wherein said first cylinder block further includes a first recess and said second cylinder block further includes a second recess, said first vane at least partially received in said first recess, and said second vane at least partially received in said second recess.

6. The compressor of claim 5, further comprising:
a fastener adjustably connected to one of said first and second cylinder blocks; and
a biasing means positioned intermediate one of said first and second vanes and said fastener for biasing said one of said first and second vanes toward said crankshaft, wherein adjustment of said fastener alters the amount of bias said biasing means exerts on said vane.

7. The compressor of claim 6 wherein said fastener is threaded, whereby rotation of said fastener alters the amount of bias said biasing means provides to said vane.

8. The compressor of claim 7, wherein said biasing means is a spring, whereby rotation of said fastener compresses said spring to increasing the biasing force of said spring toward said crankshaft.

9. The compressor of claim 6, wherein adjustment of said fastener in a direction radially inwardly toward said crankshaft increases the amount of bias of said biasing means exerts on said vane.

10. A compressor, comprising:
a housing;
a motor positioned within said housing, said motor including a crankshaft having an eccentric positioned thereon, said crankshaft rotatable about an axis;
a cylinder block having an opening, a suction inlet, and a discharge outlet, said eccentric positioned within said opening;
a vane biased against said eccentric;
a fastener adjustably engaged with said cylinder block; and
a spring positioned intermediate said vane and said fastener, wherein said spring biases said vane against said eccentric and adjustment of said fastener alters the biasing force exerted by said spring on said vane.

11. The compressor of claim 10, wherein said fastener is threadingly engaged with said cylinder block, whereby rotation of said fastener in a first direction compresses said spring between said vane and said fastener.

12. The compressor of claim 10, further including a roller operably engaged with said eccentric, wherein said vane is biased against said roller by said spring.

13. A compressor, comprising:
a housing;
a motor positioned within said housing, said motor including a crankshaft having an eccentric positioned thereon, said crankshaft rotatable about an axis;
a cylinder block having an opening, a suction inlet, and a discharge outlet, said eccentric positioned within said opening;
a vane biased against said eccentric;
a fastener adjustably engaged with said cylinder block; and
a biasing means positioned intermediate said vane and said fastener, wherein said biasing means biases said vane against said eccentric and adjustment of said fastener alters the biasing force said biasing means exerts on said vane.
